(19) United States
(12) Patent Application Publication
(10) Pub. No.: US 2015/0288239 A1
(43) Pub. Date: Oct. 8, 2015

(54) BOBBIN AND ROTATING ELECTRICAL MACHINE

(71) Applicant: KABUSHIKI KAISHA YASKAWA DENKI, Kitakyushu-shi (JP)

(72) Inventors: Toyofumi YUDA, Kitakyushu-shi (JP); Toshiyuki YAMAGISHI, Kitakyushu-shi (JP)

(73) Assignee: KABUSHIKI KAISHA YASKAWA DENKI, Kitakyushu-shi (JP)

(21) Appl. No.: 14/681,063

(22) Filed: Apr. 7, 2015

(30) Foreign Application Priority Data
Apr. 7, 2014 (JP) 2014-078450

(51) Int. Cl. H02K 3/38; H02K 3/34; H02K 3/32

(52) U.S. Cl. CPC H02K 3/38; H02K 3/325; H02K 3/345

(57) ABSTRACT

A bobbin is mountable to a stator iron core of a rotating electrical machine, and includes a body and a protrusion. Around the body, a coil wire is to be wound. The body has an opening side end. The protrusion protrudes from the opening side end of the body in a direction approximately parallel to a coil axial direction. A terminal of the coil wire is to be wound around the protrusion.

### CROSS-REFERENCE TO RELATED APPLICATIONS

The present application claims priority under 35 U.S.C. §119 to Japanese Patent Application No. 2014-078450, filed Apr. 7, 2014. The contents of this application are incorporated herein by reference in their entirety.

### BACKGROUND

1. Field Of The Invention

The embodiments disclosed herein relate to a bobbin and a rotating electrical machine.

2. Discussion Of The Background

Japanese Unexamined Patent Application Publication No. 2012-105484 discloses a bobbin including two square bar-shaped pin terminals upright on the bobbin. Around the two square bar-shaped pin terminals, terminals of a coil wire at its winding start and winding end are wound.

### SUMMARY

According to one aspect of the present disclosure, a bobbin is mountable to a stator iron core of a rotating electrical machine, and includes a body and a protrusion. Around the body, a coil wire is to be wound. The body has an opening side end. The protrusion protrudes from the opening side end of the body in a direction approximately parallel to a coil axial direction. A terminal of the coil wire is to be wound around the protrusion.

According to another aspect of the present disclosure, a rotating electrical machine includes a rotor and a stator. The stator includes a stator iron core, a plurality of the

above-described bobbins, and coil wires. The plurality of bobbins are mounted to the stator iron core. The coil wires are respectively wound around the plurality of bobbins.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a longitudinal sectional view of a rotating electrical machine according to an embodiment, illustrating a general arrangement of the rotating electrical machine;

FIG. 2 is a perspective view of a frame configuration, a stator configuration, and a wire connection board configuration;

FIG. 3A is a plan view of a bobbin around which a coil wire is wound;

FIG. 3B is a front view of the bobbin around which the coil wire is wound;

FIG. 3C is a side view of the bobbin around which the coil wire is wound;

FIG. 4 is a front view of a terminal processor of the bobbin around which no coil wire is wound;

FIG. 5 is a plan view of the terminal processor of the bobbin around which no coil wire is wound; and

FIG. 6 is a front view of the terminal processor of a bobbin according to a modification in which a projection is provided on an opening side in a pulling groove.

### DESCRIPTION OF THE EMBODIMENTS

The embodiments will now be described with reference to the accompanying drawings, wherein like reference numerals designate corresponding or identical elements throughout the various drawings. In the following description, directions are used such as upward direction, downward direction, left direction, and right direction to facilitate understanding of the configuration of the rotating electrical machine and related devices. These directions, however, should not be construed as limiting the position relationship between the components of the rotating electrical machine

### Configuration of Rotating Electrical Machine

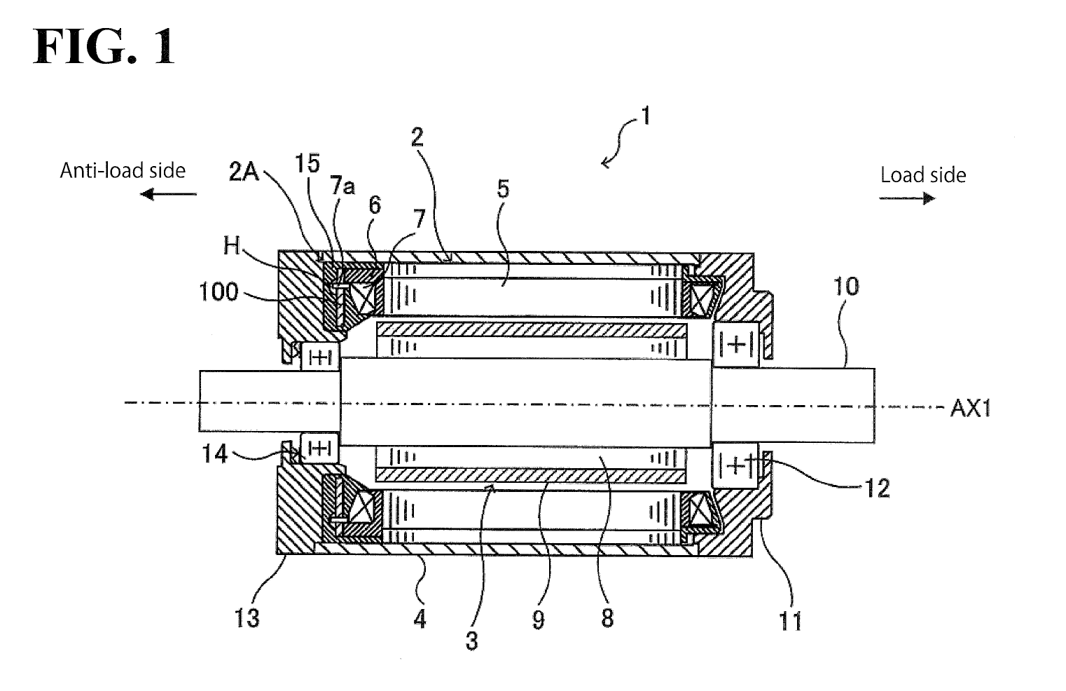

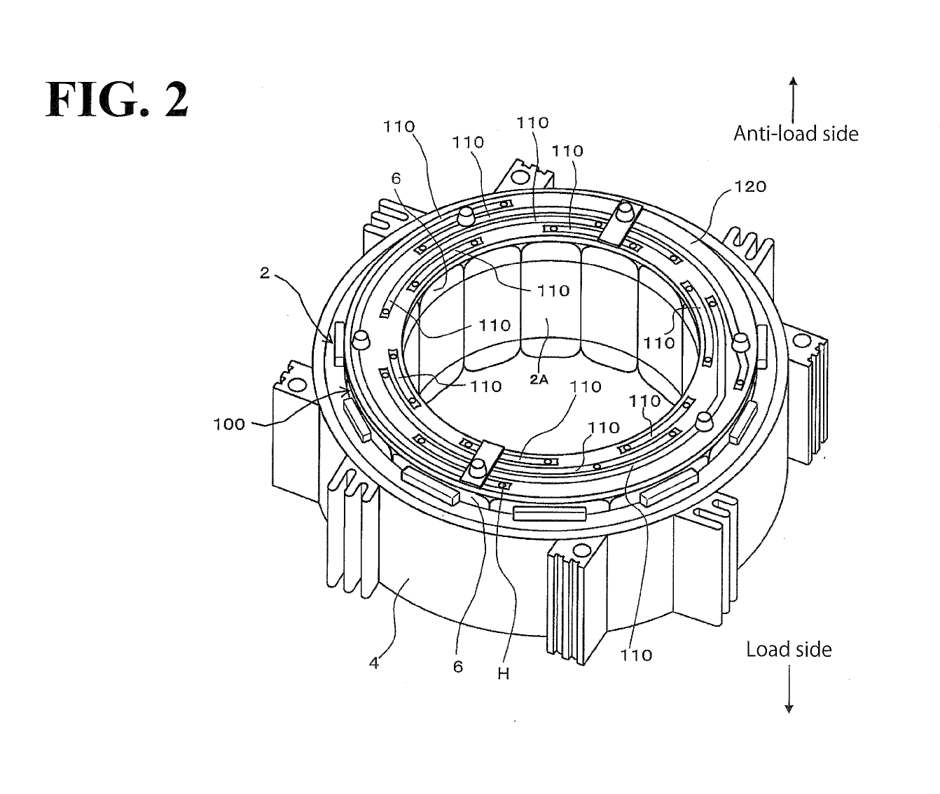

First, a configuration of a rotating electrical machine according to this embodiment will be described by referring to FIGS. 1 and 2.

As illustrated in FIGS. 1 and 2, a rotating electrical machine 1 includes a stator 2 and a rotor 3. The rotating electrical machine 1 is what is called an inner-rotor motor, with the rotor 3 disposed inside the stator 2.

The rotating electrical machine 1 includes a frame 4, the stator 2, the rotor 3, and a shaft 10. The frame 4 has an approximately hollow cylindrical shape. The stator 2 is disposed on the inner circumference of the frame 4. The rotor 3 is disposed inside the stator 2. The shaft 10 is mounted to the rotor 3. The shaft 10 is rotatably supported on a load side bracket 11 and an anti-load side bracket 13 through a load side bracket bearing 12 and an anti-load side bracket bearing 14. The load side bracket 11 covers one side (right side in FIG. 1) of the frame 4 in the rotation axis direction. The anti-load side bracket 13 covers the other side (left side in FIG. 1) of the frame 4 in the rotation axis direction. The load side bracket bearing 12 has an outer wheel fitted with the load side bracket 11. The anti-load side bracket bearing 14 has an outer wheel fitted with the anti-load side bracket 13. As used herein, the “rotation axis direction” refers to the direction of a rotation axis center AX1 of the shaft 10.

As used herein, the “load side” refers to the side (right side in FIG. 1) on which a wire connection board 100 is not mounted to the stator 2, and the “anti-load side” refers to the side (left side in FIG. 1) opposite to the load side.

The rotor 3 includes a rotor iron core 8 and a permanent magnet 9. The rotor iron core 8 has an approximately hollow cylindrical shape and fixed to the outer circumference surface of the shaft 10. The permanent magnet 9 is disposed on the rotor iron core 8. The rotor 3 faces the inner circumference surface of the stator 2 through a magnetic space in the radial direction of the rotor 3.

The stator 2 includes a plurality of stator iron cores 5, bobbins 6, and coil wires 7. The stator iron cores 5 are disposed in an approximately annular arrangement on the inner circumference of the frame 4. Each bobbin 6 is mounted to a corresponding one of the stator iron cores 5. Each coil wire 7 is wound around a corresponding one of the bobbins 6. Each stator iron core 5, each bobbin 6, and each coil wire 7 constitute a stator division body 2A, and the stator 2 is made up of a plurality of stator division bodies 2A in an approximately annular arrangement. At the anti-load side of the plurality of bobbins 6, the wire connection board 100 is disposed. The wire connection board 100 has an approximately annular shape. The coil wire 7 wound round the bobbin 6 has a winding start and a winding end. The winding start and a terminal 7a of the winding end of the coil wire 7 are fixed to the wire connection board 100 with a solder H. The wire connection board 100, the plurality of stator iron cores 5, the bobbin 6s, and the coil wires 7 are integrally covered with a resin mold 15. The resin mold 15 is made of resin and injected inside under pressure.

### Wire Connection Processing on Wire Connection Board

As illustrated in FIG. 2, the wire connection board 100 includes a plurality of conductive members 110 and an insulation member 120. The plurality of conductive members 110 each have an approximately arc shape (or approximately annular shape). The insulation member 120 has an approximately annular shape. In this embodiment, the plurality of conductive members 110 form a radially concentric quadruple structure. The insulation member 120 is made of an insert-molded resin material, for example, and covers the surfaces of the conductive members 110 at least partially. The insulation member 120 provides insulation between the plurality of conductive members 110 while fixing the plurality of conductive members 110 to predetermined positions on a common plane that is approximately perpendicular to the rotation axis direction.

The winding start and the terminal 7a of the winding end of the coil wire 7 wound around each bobbin 6 are pulled to the anti-load side and passed through through-holes of a corresponding conductive member 110 through tapered holes (not illustrated) disposed on the insulation member 120 of the wire connection board 100, which is placed on the plurality of bobbins 6. With the winding start and the terminal 7a of the winding end in this state, the wire connection board 100 is fixed to all the bobbins 6. Then, unnecessary portions of the coil wire 7 are cut off so that each terminal 7a protrudes slightly beyond the anti-load side surface of the conductive member 110. Next, each terminal 7a is fixed to a corresponding conductive member 110 by soldering using the solder H. Thus, the wire connection processing ends, when the plurality terminals 7a are connected to the wire connection board 100 in a predetermined wire connection pattern (resulting in the state illustrated in FIG. 2).

It should be noted that the above-described configuration of the wire connection board 100 is provided for exemplary purposes only and should not be construed in a limiting sense. In addition, a board may not necessarily be used in the wire connection of the terminal 7a of the coil wire 7; it is possible to implement the wire connection portion without a board.

### Configuration of Bobbin

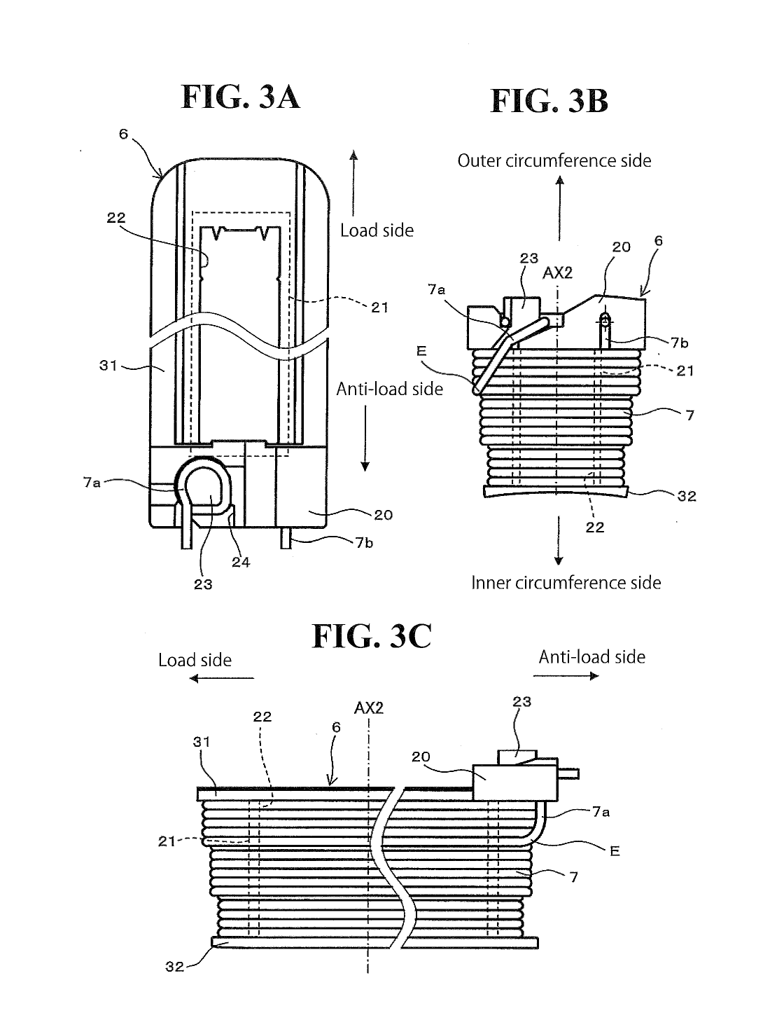

FIGS. 3A to 3C illustrate the bobbin around which the coil wire is wound. FIG. 3A is a plan view of the bobbin from the outer circumference of the stator. FIG. 3B is a front view of the bobbin from the anti-load of the stator. FIG. 3C is a side view of the bobbin from the circumferential direction of the stator.

The bobbin 6 includes a body 21, a first flange 31, and a second flange 32. Around the outer circumference of the body 21, the coil wire 7 is wound. The first flange 31 is disposed at one opening side end on the outer circumference side of the body 21. The second flange 32 is disposed at the other opening side end on the inner circumference side of the body 21. As illustrated in FIG. 3A, the body 21 has a cylindrical shape that has an approximately rectangular shape when the body 21 is viewed from the coil axial direction (direction of the coil axis center AX2). The body 21 has a rectangular opening 22. In the rectangular opening 22, the stator iron core 5 is disposed. The coil wire 7 is wound around the body 21 in an aligned manner using both surfaces of the body 21 in the circumferential direction and one of the load side surface and the anti-load side surface of the body 12, and using the other one of the load side surface and the anti-load side surface of the body 12, generally the anti-load side surface, to move the winding position.

The bobbin 6 includes a protrusion 23. The protrusion 23 protrudes from the opening side end of the body 21 toward the outer circumference side in a direction approximately parallel to the coil axial direction. The terminal 7a of the coil wire 7 is wound around the protrusion 23. In this embodiment, the protrusion 23 has an approximately solid cylindrical shape with a flat portion on the anti-load side, and is disposed at the short side of the body 21 on the anti-load side. Specifically, a terminal processor 20 is disposed at the opening side end of the body 21 on the outer circumference side. In the terminal processor 20, the wire connection board 100 (see FIG. 2) is placed. The protrusion 23 is disposed on the outer circumference side of the terminal processor 20. The terminal processor 20 pulls the terminal 7a of the winding end and another terminal 7b of the winding start of the coil wire 7 wound around the protrusion 23 along the rotation axis direction to the anti-load side.

In this embodiment, the terminal processor 20 pulls both the terminal 7a of the winding end and the terminal 7b of the winding start of the coil wire 7. This, however, this should not be construed in a limiting sense. Another possible example is to pull the terminal 7b of the winding start from the second flange 32 and pull only the terminal 7a of the winding end from the terminal processor 20.

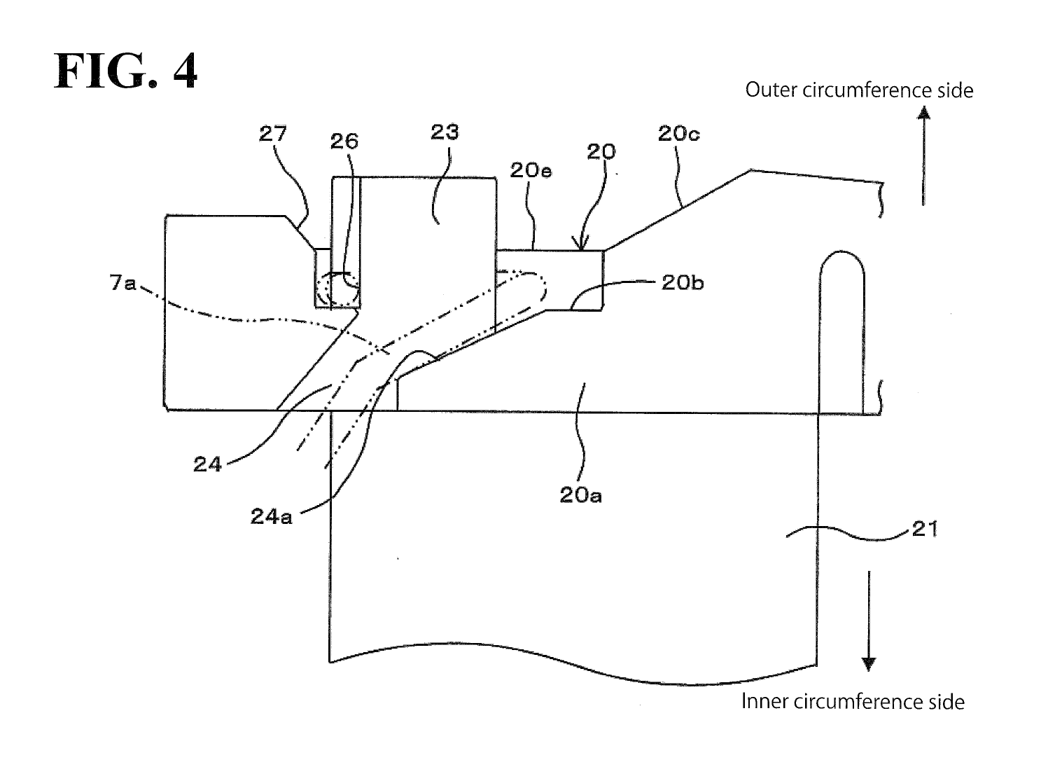

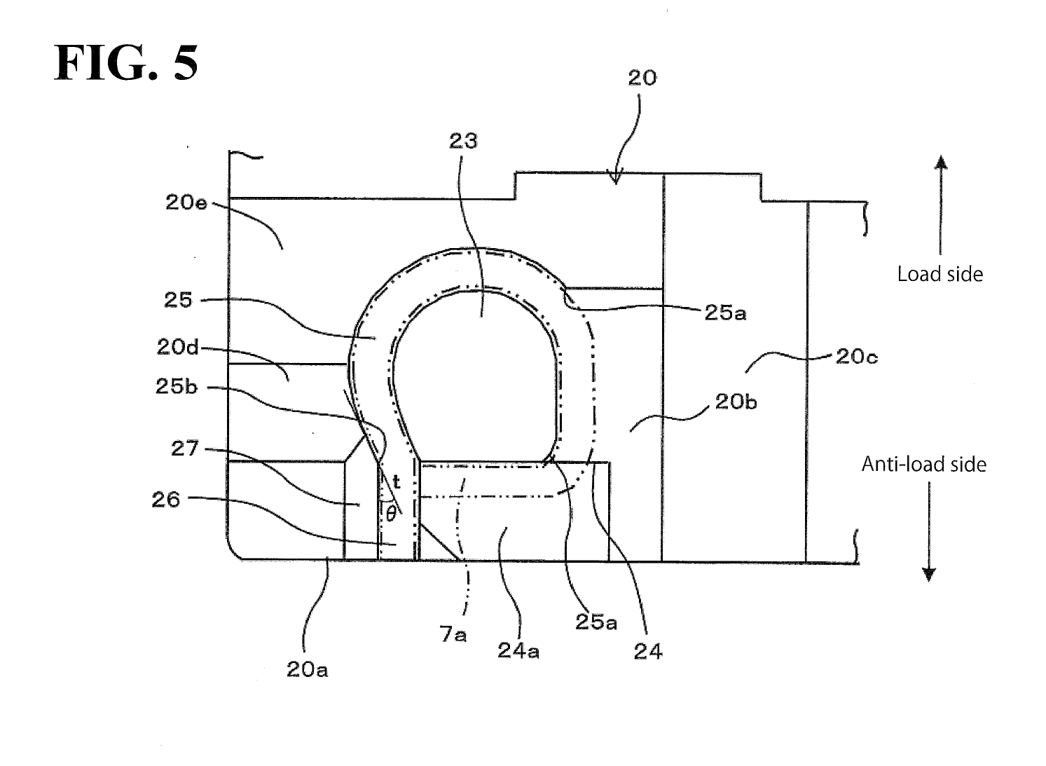

FIGS. 4 and 5 illustrate the terminal processor 20 without the coil wire wound around the terminal processor 20. As illustrated in FIGS. 4 and 5, the terminal processor 20 includes a guide groove 24. The guide groove 24 guides the terminal 7a of the coil wire 7 from a winding end position E (see FIGS. 3B and 3C) of the body 21 to the protrusion 23. The guide groove 24 is disposed at an end 20a of the terminal processor 20 on the anti-load side in the form of a depression in the load side direction. The guide groove 24 includes a slope 24a to guide the terminal 7a to a depression 20b. The wire connection board 100 is placed on the end 20a of the terminal processor 20.

The terminal processor 20 also includes a circumferential groove 25 around the protrusion 23 to receive at least a part of the terminal 7a surrounding the protrusion 23. The circumferential groove 25 has an approximately arc shape around the approximately solid cylindrical protrusion 23. The circumferential groove 25 includes an end 25a on one side of the circumferential groove 25. The end 25a is coupled to the depression 20b. The terminal processor 20 includes tapered portions 20c and 20d on the surface of the terminal processor 20 on the outer circumference side. This keeps a surface 20e around the protrusion 23 lower than the protrusion 23, and facilitates the winding of the terminal 7a of the coil wire 7 around the protrusion 23.

The terminal processor 20 also includes a pulling groove 26 along the rotation axis direction. At one end, the pulling groove 26 is coupled to the other end 25b of the circumferential groove 25. At another end, the pulling groove 26 is open to the end 20a on the anti-load side of the terminal processor 20. The pulling groove 26 is coupled to the other end 25b of the circumferential groove 25 at such a predetermined angle θ that the pulling groove 26 is inclined toward the outer circumference side (radially outward direction of a circle centered around the center axis of the protrusion 23) relative to the direction of a tangent t of the end 25b. The terminal processor 20 also includes a tapered portion 27 at least at one of an opening of the circumferential groove 25 and an opening of the pulling groove 26. In this embodiment, the tapered portion 27 is disposed at a part (end 25b) of the opening of the circumferential groove 25 and the opening of the entire pulling groove 26.

In the above description, the protrusion 23 is an example of the means for preventing the coil wire from collapsing.

### Advantageous Effects of the Embodiment

In this embodiment, the bobbin 6 is mounted to the stator iron core 5 of the rotating electrical machine 1, and includes the body 21 and the protrusion 23. Around the body 21, the coil wire 7 is to be wound. The protrusion 23 protrudes from the opening side end of the body 21 in a direction approximately parallel to the coil axial direction. The terminal 7a of the coil wire 7 is wound around the protrusion 23, as described above. This ensures holding of the terminal 7a without a pin terminal, and thus eliminates or minimizes collapse of the coil wire even when the coil wire has a larger diameter.

In addition, the protrusion 23 protrudes in a direction approximately parallel to the coil axial direction, and the terminal 7a is spirally wound along a direction approximately perpendicular to the pulling direction (rotation axis direction). This ensures stability in determining the position to which the terminal 7a is pulled to the wire connection board 100 side, and eliminates or minimizes looseness in winding the terminal 7a around the protrusion 23. In addition, the dimension of the bobbin 6 in the rotation axis direction is shortened and thus the rotating electrical machine 1 is reduced in size in the rotation axis direction compared with, for example, the configuration in which the protrusion 23 protrudes in the rotation axis direction from the opening side end of the body 21.

It is particularly noted that in this embodiment, the body 21 has an approximately rectangular shape when the body 21 is viewed from the coil axial direction, and the protrusion 23 is disposed at the short side of the body 21. This ensures that an outermost part of the coil wire 7 is made to cross itself at the short side of the body 21 and is guided to the protrusion 23, where the coil wire 7 is wound. As a result, the outermost part of the coil wire 7 effects inward tension to eliminate or minimize collapse of the winding.

In particular, the configuration of this embodiment is effective when the winding end position E at the outermost part of the coil wire around the body 21 is away from the first flange 31 (terminal processor 20) as illustrated in FIGS. 3A to 3B. Specifically, in an exemplary case where the terminal 7a of the coil wire 7 is wound at the long side of the body 21 of the bobbin 6, it is possible to eliminate or minimize collapse of the winding when the winding end position E is close to the first flange 31 (terminal processor 20). However, the winding may collapse when the winding end position E is away from the first flange 31 (terminal processor 20). In this embodiment, the protrusion 23 is disposed at the short side of the body 21, as described above. This ensures that the coil wire 7 is held at the corner (winding end position E) defined between the long side and the short side, and is made to cross the coil wire 7 itself at the short side to be wound around the protrusion 23. As a result, the outermost part of the coil wire 7 effects inward tension to eliminate or minimize collapse of the winding.

It is particularly noted that in this embodiment, the bobbin 6 is disposed at the opening side end of the body 21. The bobbin 6 includes the terminal processor 20 to pull the terminal 7a wound around the protrusion 23 to the anti-load side. The protrusion 23 is disposed at the terminal processor 20. This ensures smoothness in guiding the terminal 7a of the coil wire 7 to the wire connection board 100, which is disposed on the anti-load side of the bobbin 6 in the rotating electrical machine 1.

It is particularly noted that in this embodiment, the terminal processor 20 includes the guide groove 24 to guide the terminal 7a of the winding end of the coil wire 7 toward the protrusion 23 from the winding end position E on the body 21. This ensures smoothness in guiding the terminal 7a of the coil wire 7 to the protrusion 23. In addition, the coil wire 7 is fitted in the guide groove 24. This eliminates or minimizes roughness attributed to the coil wire 7 on the surface of the end 20a of the terminal processor 20. This, in turn, ensures that the wire connection board 100 can be mounted on the end 20a of the terminal processor 20.

It is particularly noted that in this embodiment, the terminal processor 20 includes the circumferential groove 25 around the protrusion 23 to receive at least a part of the terminal 7a of the coil wire 7 surrounding the protrusion 23. With the terminal 7a of the coil wire 7 fitted in the circumferential groove 25, the terminal 7a is held while being wound around the protrusion 23.

It is particularly noted that in this embodiment, the terminal processor 20 includes the pulling groove 26 along the rotation axis direction. The pulling groove 26 has one end coupled to the end 25b of the circumferential groove 25 and has the other end open to the end 20a of the terminal processor 20 on the anti-load side. With the terminal 7a of the coil wire 7 fitted in the pulling groove 26, the position to which the terminal 7a is pulled to one side in the rotation axis direction is determined accurately.

It is particularly noted that in this embodiment, the protrusion 23 has an approximately solid cylindrical shape, and the circumferential groove 25 is an arc shaped groove around the approximately solid cylindrical shape of the protrusion 23. The pulling groove 26 is coupled to the end 25b of the circumferential groove 25 at such an angle that the pulling groove 26 is inclined toward the outer circumference side relative to the direction of the tangent t of the end 25b. This increases the amount of the terminal 7a of the coil wire 7 that can be wound around the protrusion 23, thereby enhancing the effect of holding the terminal 7a. This also ensures fine adjustment of the position to which the terminal 7a is pulled to one side in the rotation axis direction.

It is particularly noted that in this embodiment, the terminal processor 20 includes the tapered portion 27 at least at one of the opening of the circumferential groove 25 and the opening of the pulling groove 26. This facilitates the fitting of the terminal 7a of the coil wire into the circumferential groove 25 and the pulling groove 26.

### Modification

The disclosed embodiment should not be construed in a limiting sense, and various modifications are possible without departing from the technical scope of the present disclosure.

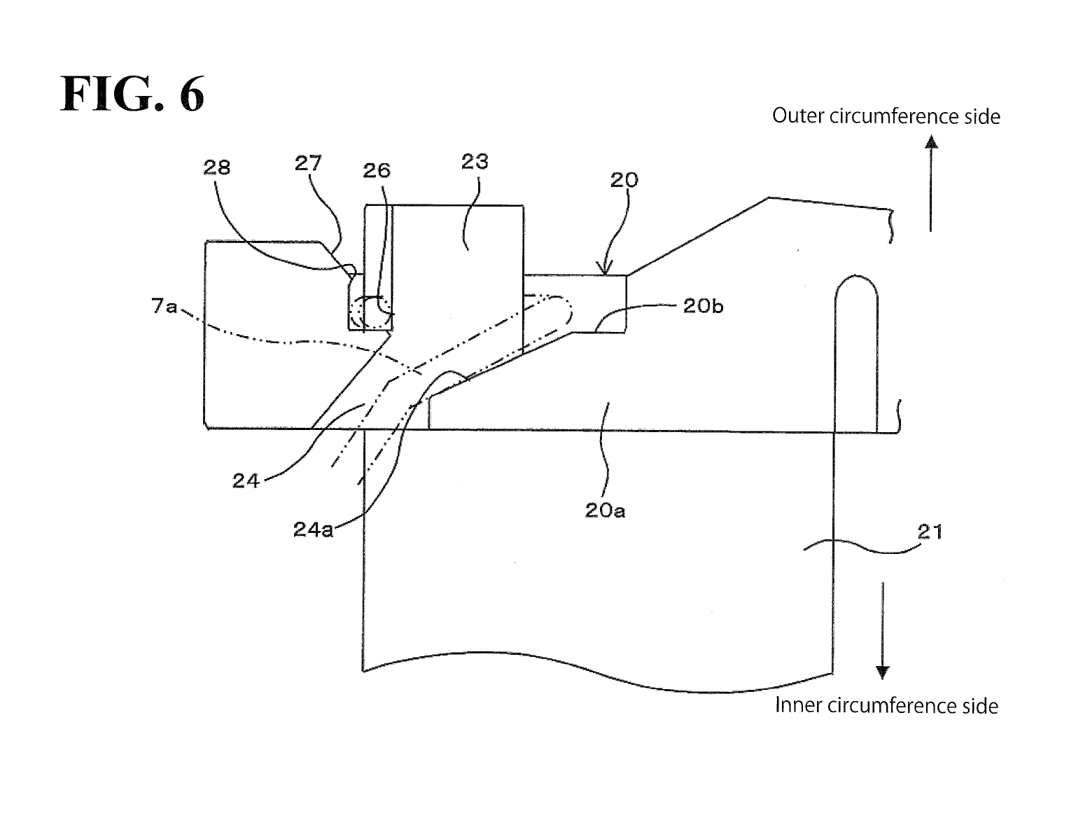

For example, as illustrated in FIG. 6, a projection 28 may be formed on the opening side in the pulling groove 26 of the terminal processor 20. The projection 28 may be disposed over the entire length of the pulling groove 26 in the longitudinal direction, or may be disposed at irregular intervals over the pulling groove 26. The modification is otherwise similar to the above-described embodiment and will not be elaborated further here.

In this modification, the projection 28 enhances the effect of eliminating or

minimizing displacement of the terminal 7a of the coil wire 7 out of the pulling groove 26. It is also possible to provide another projection in the circumferential groove 25 in order to further enhance the effect of eliminating or minimizing displacement of the terminal 7a out of the groove.

In the above-described embodiment, the rotating electrical machine 1 has been described as an inner-rotor motor. The rotating electrical machine 1 may also be what is called an outer-rotor motor, in which the rotor is disposed outside the stator. The above-described embodiment also finds applications in which the rotating electrical machine is an electric generator.

As used herein, the terms “perpendicular”, “parallel”, and “plane” may not necessarily mean “perpendicular”, “parallel”, and “plane”, respectively, in a strict sense. Specifically, the terms “perpendicular”, “parallel”, and “plane” mean “approximately perpendicular”, “approximately parallel”, and “approximately plane”, respectively, taking design-related and production-related tolerance and error into consideration.

Also, when the terms “same”, “equal”, and “different” are used in the context of dimensions or sizes of external appearance, these terms may not necessarily mean “same”, “equal”, and “different”, respectively, in a strict sense. Specifically, the terms “same”, “equal”, and “different” mean “approximately same”, “approximately equal”, and “approximately different”, respectively, taking design-related and production-related tolerance and error into consideration.

Otherwise, the above-described embodiments and modifications may be combined in any manner deemed suitable.

Obviously, numerous modifications and variations of the present disclosure are possible in light of the above teachings. It is therefore to be understood that within the scope of the appended claims, the present disclosure may be practiced otherwise than as specifically described herein.

What is claimed as new and desired to be secured by Letters Patent of the United States is:

1. A bobbin mountable to a stator iron core of a rotating electrical machine, the bobbin comprising:
a body around which a coil wire is to be wound and which comprises an opening side end; and
a protrusion protruding from the opening side end of the body in a direction approximately parallel to a coil axial direction, a terminal of the coil wire being to be wound around the protrusion.

2. The bobbin according to claim 1,
wherein the body comprises a hollow cylindrical shape comprising an approximately rectangular shape when the body is viewed from the coil axial direction, and
wherein the protrusion is disposed at a short side of the body.

3. The bobbin according to claim 1, further comprising a terminal processor disposed at the opening side end of the body to pull the terminal of the coil wire wound around the protrusion to one side in a rotation axis direction,
wherein the protrusion is disposed at the terminal processor.

4. The bobbin according to claim 3, wherein the terminal processor comprises a guide groove configured to guide the terminal of the coil wire from a winding end position on the body toward the protrusion.

5. The bobbin according to claim 4, wherein the terminal processor comprises a circumferential groove disposed around the protrusion to receive at least a part of the terminal surrounding the protrusion.

6. The bobbin according to claim 5, wherein the terminal processor comprises a pulling groove along the rotation axis direction, the pulling groove comprising one end coupled to an end of the circumferential groove and comprising another end open to an end of the terminal processor on the one side in the rotation axis direction.

7. The bobbin according to claim 6,
wherein the protrusion comprises an approximately solid cylindrical shape, and the circumferential groove comprises an arc shaped groove around the approximately solid cylindrical shape of the protrusion, and
wherein the pulling groove is coupled to the end of the circumferential groove at such an angle that the pulling groove is inclined toward an outer circumference side relative to a direction of a tangent of the end of the circumferential groove.

8. The bobbin according to claim 6, wherein the terminal processor comprises a tapered portion at least at one of an opening of the circumferential groove and an opening of the pulling groove.

9. The bobbin according to claim 6, wherein at least one of the circumferential groove and the pulling groove comprises a projection on an opening side in at least one of the circumferential groove and the pulling groove.

10. A rotating electrical machine comprising:
a rotor; and
a stator comprising:
a stator iron core;
a plurality of bobbins according to claim 1, the plurality of bobbins being mounted to the stator iron core; and
coil wires respectively wound around the plurality of bobbins.

11. The bobbin according to claim 2, farther comprising a terminal processor disposed at the opening side end of the body to pull the terminal of the coil wire wound around the protrusion to one side in a rotation axis direction,
wherein the protrusion is disposed at the terminal processor.

12. The bobbin according to claim 11, wherein the terminal processor comprises a guide groove configured to guide the terminal of the coil wire from a winding end position on the body toward the protrusion.

13. The bobbin according to claim 12, wherein the terminal processor comprises a circumferential groove disposed around the protrusion to receive at least a part of the terminal surrounding the protrusion.

14. The bobbin according to claim 13, wherein the terminal processor comprises a pulling groove along the rotation axis direction, the pulling groove comprising one end coupled to an end of the circumferential groove and comprising another end open to an end of the terminal processor on the one side in the rotation axis direction.

15. The bobbin according to claim 14,
wherein the protrusion comprises an approximately solid cylindrical shape, and the circumferential groove comprises an arc shaped groove around the approximately solid cylindrical shape of the protrusion, and
wherein the pulling groove is coupled to the end of the circumferential groove at such an angle that the pulling groove is inclined toward an outer circumference side relative to a direction of a tangent of the end of the circumferential groove.

16. The bobbin according to claim 14, wherein the terminal processor comprises a tapered portion at least at one of an opening of the circumferential groove and an opening of the pulling groove.

17. The bobbin according to claim 15, wherein the terminal processor comprises a tapered portion at least at one of an opening of the circumferential groove and an opening of the pulling groove.

18. The bobbin according to claim 7, wherein at least one of the circumferential groove and the pulling groove comprises a projection on an opening side in at least one of the circumferential groove and the pulling groove.

19. The bobbin according to claim 8, wherein at least one of the circumferential groove and the pulling groove comprises a projection on an opening side in at least one of the circumferential groove and the pulling groove.

20. A bobbin mountable to a stator iron core of a rotating electrical machine, the bobbin comprising:
a body around which a coil wire is to be wound; and
means for preventing the wound coil wire from collapsing.
